(19) United States
(12) Patent Application Publication
(10) Pub. No.: US 2025/0256807 A1
(43) Pub. Date: Aug. 14, 2025

(54) TENSIONER DEVICE TO ACCOUNT FOR VIRTUAL CHAIN GROWTH IN INTERNALLY GEARED HIGH PIVOT POINT REAR SUSPENSION BICYCLES

(71) Applicant: Priority Outdoor Products, LLC, New York, NY (US)

(72) Inventors: Fabien Gaston Lemasson, Lignieres-Orgeres (FR); Michael Schwartz, Douglaston, NY (US)

(21) Appl. No.: 18/439,787

(22) Filed: Feb. 13, 2024

(51) Int. Cl. B62M 9/16

(52) U.S. Cl. CPC B62M 9/16

(57) ABSTRACT

A rear suspension bicycle having a suspension pivot point sufficiently above a crank axis (front sprocket/chainring) to provide predominantly rearward axle path and require an idler pulley to route a drive belt/chain. A tensioner is located between the idler pulley and the front sprocket/chainring to accommodate virtual chain growth and maintain appropriate tension on drive belt/chain. The tensioner includes a pivoting member with a pulley mounted thereto, a spring arm connected to the pivoting member at a defined angle, and a spring located between the spring arm and a frame. The pivoting member/pulley pivot away from the suspension pivot point to accommodate the virtual chain growth created when vertical rear wheel travel of bicycle increases. The pivoting member/pulley pivot back toward the suspension pivot point to maintain appropriate tension when vertical rear wheel travel decreases. A spring returning to its steady state size (e.g., expanding) is used to maintain tension.

### BACKGROUND

FIG. 1 illustrates a line diagram of an example chain driven rear suspension bicycle 100. The bicycle 100 includes a frame made up of a front triangle 110 and a swingarm (rear triangle) 130. The front triangle 110 includes a seat tube 112, a top tube 114 and a down tube 116. The top tube 114 and the down tube 116 are connected to a head tube 118 that connects to handlebars (not illustrated) and a front fork 120 that is used to secure a front wheel (not illustrated) at a front wheel axle (axis) 122. The seat tube 112 and the down tube 116 are connected to each other via a bottom bracket shell (not separately illustrated, just shown as point of intersection between seat tube 112 and the down tube 116 for ease of illustration). The swingarm 130 may include a seatstay 132 and a chainstay 134, or a combined chain and seatstay 134 alone in case of a mono-arm bicycle. The seatstay 132 and the chainstay 134 meet to secure a rear wheel (not illustrated) at a rear wheel axle (axis) 136. For a mono-arm bicycle, simply the combined chain and seatstay 134 would secure the rear wheel.

The swingarm 130 may be connected to the front triangle 100 via a shock absorber or other linkages that are not illustrated for simplicity. The bicycle 100 also includes a rear suspension axis 140 (main pivot point). It should be noted that the rear suspension axis 140 could have a floating or virtual pivot, which may or may not coincide with a physical point on the bicycle frame, where the axis is found at an instant center that varies depending on the rear suspension position. In this case, the rear wheel axle 136 may be connected to either the seatstay 132 or the chainstay 134. A floating pivot is not illustrated for ease of illustration and simplicity of explaining the basic components.

The bicycle 100 also includes a drive train 150 for providing movement thereof. The drivetrain 150 consists of a chain drive 152, a rear cassette 154 and a front chain ring 156. The rear cassette 154 is located on the rear wheel centered around the rear wheel axle 136. The rear cassette 154 includes a plurality of different sized cogs 158 (to achieve different gear ratios) for receiving and routing the chain drive 152. The front chain ring 156 is located on the bottom bracket shell. The chain drive 152 routes around the appropriate cog 158 of the rear cassette 154 and the front chainring 156. An upper portion of the chain drive 152U moves forward from the rear cassette 154 to the front chainring 156 and a lower portion of the chain drive 152L moves rearward from the front chainring 156 to the rear cassette 154. The bottom bracket shell enables a crank set and pedals (not illustrated) to be connected thereto and create a crank axis 160 (simply shown as point of intersection between seat tube 112 and the down tube 116 for ease of illustration). The crank axis 160 enables a user to pedal the bicycle 100 in order to engage the drive train 150 and move the bicycle 100. The pedaling causes the rotation of the front chain ring 156 which will in turn rotates the chain drive 152 and the appropriate cog 158 of the rear cassette 154 and the rotation of the cog 158 causes rotation of the rear wheel. If the bicycle 100 is an electric bicycle, it will include an electric motor (not illustrated) to provide, or assist with, the movement of the bicycle 100.

The amount of the chain drive 152 required to route around a larger cog 158 of the rear cassette 154 and the front chainring 156 is more than is required to route the chain drive 152 around a smaller cog 158. The extra chain drive 152 required is known as virtual chain growth. To account for the chain growth, a derailleur 162 is utilized to take up the slack therein based on the cog 158 that the chain drive 152 is routed around. The derailleur 162 is a rotating member 164 onto which two idler pulleys 166 are mounted. The derailleur 162 is secured to the swingarm 130 in close proximity to the rear cassette 154 and is spring loaded to rotate the rotating member 164 and the idler pulleys 166 based on the rear cog size 158. This allows for virtual chain growth that results from shifting the chain to different sized cogs 158 on the rear cassette 154.

In addition to the cog 158 utilized affecting chain growth, a vertical distance that the rear wheel axis 136 travels with respect to its resting position (known as vertical rear wheel travel) may result in chain growth. That is, as the rear wheel axis 136 moves upward along a path defined by the rear suspension axis 140, if the distance between the rear wheel axis 136 and the crank axis 160 increases, it will result in chain growth. As with most mechanical vehicle suspension systems, a bicycle 100 with rear suspension will be designed such that the swingarm 130, as it moves throughout its range of vertical rear wheel travel, will act upon a shock absorber resulting in a displacement of a spring. This spring displacement (suspension compression) absorbs shock impulses to the bicycle 100 by converting kinetic energy into thermal energy.

FIG. 2 illustrates a simple graph showing that chain growth increases nearly linearly as vertical rear wheel travel increases. The amount of chain growth will depend on the frame and suspension geometry and kinematics, as well as the front and rear sprocket size combination.

FIGS. 3A-D illustrate simplified line diagrams of the example chain driven rear suspension bicycle 100 of FIG. 1 in different gear ratios and rear suspension positions. FIG. 3A illustrates the bicycle 100 in a gear associated with the chain drive 152 routing around a larger cog of the rear cassette (not illustrated or identified in simplified drawing). The derailleur 162 provides an angle 310 in the routing of the chain drive 152 (driveline angle 310) to provide the appropriate tension thereto based on the gear. FIG. 3B illustrates the bicycle 100 in the same gear as FIG. 3A but with the bicycle 100 experiencing a vertical rear wheel travel 320. The vertical rear wheel travel 320 accounts for additional chain growth so that the driveline angle 330 is increased (angle 330 is greater than angle 310) to provide the appropriate tension thereto based on the gear. The increased driveline angle is the result of the rear wheel axle 136 moving away from the crank axis 160 as the vertical rear wheel travel 320 increases and the fixed length of the chain drive 152.

FIG. 3C illustrates the bicycle 100 in a gear associated with the chain drive 152 routing around a smaller cog of the rear cassette (not illustrated or identified in simplified drawing). The derailleur 162 provides a driveline angle 340 in the routing of the chain drive 152 to provide the appropriate tension thereto based on the gear. Note the angle 340 is smaller than the angle 310 since the chain drive 152 has a lesser distance to wrap around the smaller cog of the rear cassette. FIG. 3D illustrates the bicycle 100 in the same gear as FIG. 3C but with the bicycle 100 experiencing a vertical rear wheel travel 350. The vertical rear wheel travel accounts for additional chain growth so that the driveline angle 360 is increased (angle 360 is greater than angle 340). The increased driveline angle is the result of the rear wheel axle 136 moving away from the crank axis 160.

As FIGS. 3A-D clearly illustrate the derailleur 162 fulfills the dual purpose of varying external gear ratio with a cassette as well as accommodating chain growth based on vertical rear wheel travel.

FIG. 4 illustrates a line diagram of an example belt driven rear suspension bicycle 400. As the bicycle 400 has many of the same components as the bicycle 100, the same reference numbers are used to identify them and they are not described below to avoid redundancy. The bicycle 400 includes a drive train 450 that consists of a drive belt 452, a rear sprocket 454 and a front sprocket 456. The sprockets 454, 456 simply route the belt drive 452 and do not provide different gear ratios (provides single external gear ratio). Accordingly, the bicycle 400 may provide a gear box (not illustrated) located at the intersection between seat tube 112 and the down tube 116 (e.g., the crank axis 160) or a geared hub (not illustrated) located at the rear wheel axle 136 to provide internal gear ratios. If used, the gear box is secured to the seat tube 112 and the down tube 116 via a gear box mounting bracket. The rear sprocket 454 is located on the rear wheel centered around the rear wheel axle 136. The front sprocket 456 is located on the gear box or the bottom bracket shell. The drive belt 452 routes around the rear sprocket 454 and the front sprocket 456 with the upper portion 452U moving forward from the rear sprocket 454 to the front sprocket 456 and a lower portion 452L moving rearward from the front sprocket 456 to the rear sprocket 454. If the gear box is used a crank set and pedals (not illustrated) are connected thereto to create the crank axis 160. If the geared hub is used the crank set and pedals are connected to the bottom bracket shell as discussed above with respect to FIG. 1. In either case, the crank axis 160 enables a user to pedal the bicycle 400. Pedaling causes the rotation of the front sprocket 456 which will in turn rotate the drive belt 452 which in turn will rotate the rear sprocket 454 and the rear wheel.

It should be noted that the bicycle 400 having only a single external gear ratio, is not limited to being a belt driven bicycle. Rather, the bicycle could be a chain driven bicycle and utilize a chain drive and front and rear chain rings instead of the drive belt 452, the front sprocket 456 and the rear sprocket 454. If the bicycle 400 is an electric bicycle, it will include an electric motor (not illustrated) to provide, or assist with, the movement of the bicycle 400.

As the bicycle 400 is a single external gear ratio there is no chain growth (typically called chain growth even when a drive belt 452 is utilized) to account for so there is no need for a derailleur to adjust the tension of the drive belt 452. However, as with the bicycle 100, vertical rear wheel travel may result in chain growth. Accordingly, the bicycle 400 includes a tensioner 462 to account for the chain growth resulting from vertical rear wheel travel. The tensioner 462 is a rotating member 464 onto which an idler pulley 466 is mounted. The tensioner 462 may be secured to the front triangle 110 and be located behind the front sprocket 456 (contacts the drive belt 452 behind the front sprocket 456). The tensioner 462 is spring loaded to rotate the rotating member 464 and the idler pulley 466 to adjust the path of the drive belt 452 based on the vertical rear wheel travel. This allows for virtual chain growth that results from vertical rear wheel travel and appropriate tensioning of the drive belt 452.

FIGS. 5A-B illustrate simplified line diagrams of the example belt driven rear suspension bicycle 400 (or any single external gear ratio rear suspension bicycle) showing chain growth based on vertical real wheel travel. FIG. 5A illustrates the bicycle 400 in an initial position and FIG. 5B illustrates the bicycle 400 with the rear wheel experiencing a vertical rear wheel travel 500. At the vertical rear wheel travel 500, the length of the drive belt 452 required to be routed around the rear wheel axle 136 and the crank axis 160 has increased, resulting in a chain growth 510.

FIGS. 6A-B illustrate simplified line diagrams of the example belt driven rear suspension bicycle 400 with the tensioner 462 accounting for chain growth due to vertical rear wheel travel. The actual components (e.g., arm, pulley, springs) of the tensioner 462 are not illustrated for simplicity. Rather, the tensioner 462 is simply illustrated as providing an angle in the routing of the drive belt 452 (driveline angle) to provide the appropriate tension. The more vertical rear wheel travel that the bicycle experiences, the greater the driveline angle. FIG. 6A illustrates the bicycle 400 in an initial position having a driveline angle 600. The initial position is prior to the rear wheel experiencing any vertical rear wheel travel (e.g., not engaging the rear suspension). FIG. 6B illustrates the bicycle 400 experiencing vertical rear wheel travel 610 and having a driveline angle 620. As the vertical rear wheel travel 610 accounts for additional chain growth the driveline angle 620 increased (angle 620 is greater than angle 600) to provide the appropriate tension thereto. The increased driveline angle is the result of the rear wheel axle 136 moving away from the crank axis 160 as the vertical rear wheel travel 610 increases and the fixed length of the drive belt 452.

As chains and belts are inelastic, the maximum vertical rear wheel travel will be restricted by the amount of chain growth that can be accommodated by a derailleur or a tensioner. Furthermore, even if a long enough chain or belt is used to accommodate for chain growth at maximum vertical rear wheel travel, the increased tension of the belt or chain at the extreme end of the vertical rear wheel travel will have the effect of resisting the compression of the shock absorber, thus reducing the efficacy of the suspension at isolating the rider of the bicycle from road surface imperfections. As such, solutions to reduce chain growth are required.

### BRIEF DESCRIPTION OF DRAWINGS

The features and advantages of the various embodiments will become apparent from the following detailed description in which:

FIG. 1 illustrates a line diagram of an example chain driven rear suspension bicycle.

FIG. 2 illustrates a simple graph showing that chain growth increases nearly linearly as vertical rear wheel travel increases.

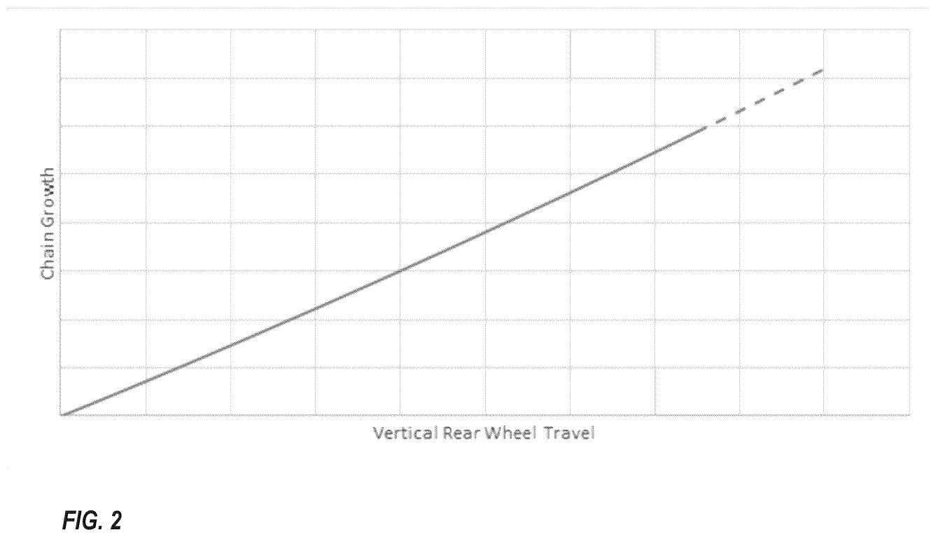

FIGS. 3A-D illustrate simplified line diagrams of example chain driven rear suspension bicycle of FIG. 1 in different gear ratios and rear suspension positions.

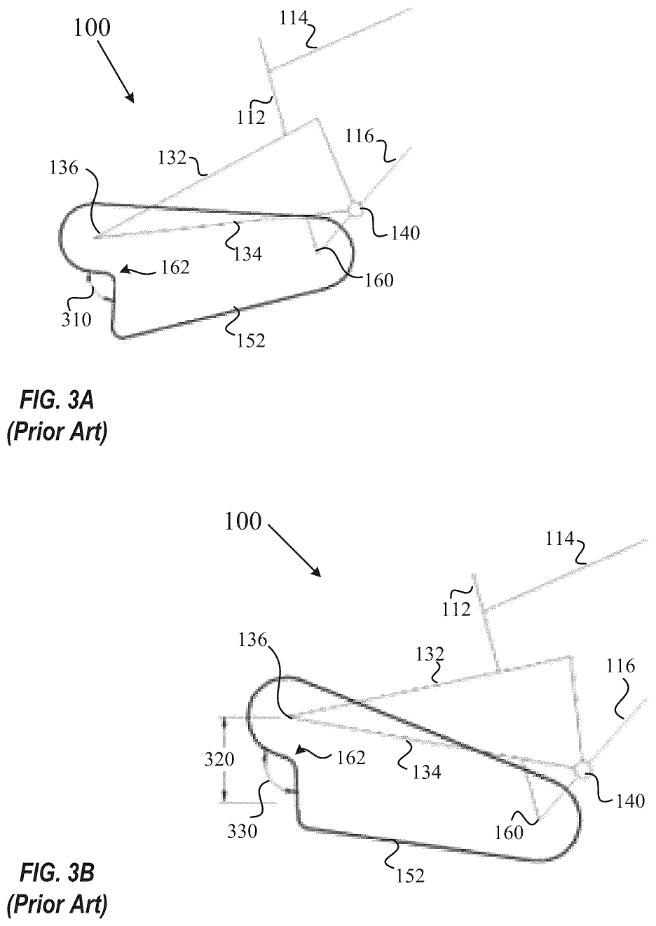

FIG. 4 illustrates a line diagram of an example belt driven rear suspension bicycle.

FIGS. 5A-B illustrate simplified line diagrams of the example belt driven rear suspension bicycle of FIG. 4 showing chain growth based on vertical real wheel travel.

FIGS. 6A-B illustrate simplified line diagrams of the example belt driven rear suspension bicycle of FIG. 4 with the tensioner accounting for chain growth due to vertical rear wheel travel.

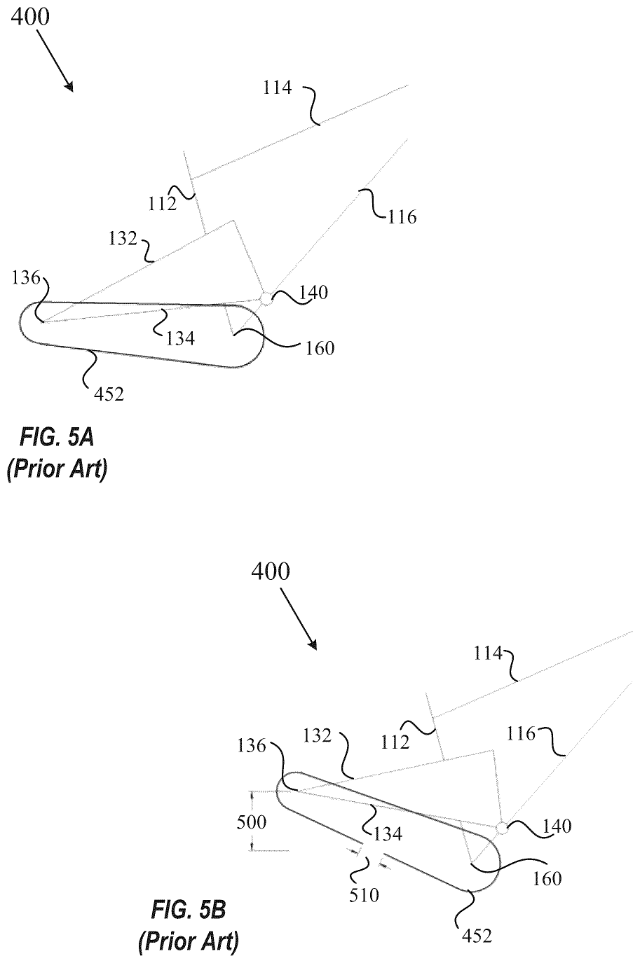

FIG. 7 illustrates a graph showing how X location (backwards and forwards) and Y location (up and down) of the suspension pivot affect chain growth.

FIGS. 8A-B illustrate simple line diagrams of an example internally geared (e.g., belt driven) high pivot point rear suspension bicycle in different rear suspension positions, according to one embodiment.

FIGS. 9A-C illustrate simple line diagrams of an example internally geared high pivot rear suspension bicycle utilizing a tensioner to account for virtual chain growth due to vertical rear wheel travel, according to one embodiment.

FIG. 10 illustrates a line diagram of an example internally geared (belt driven) high pivot point rear suspension bicycle including a highly placed tensioner, according to one embodiment.

FIGS. 11A-B illustrate simplified line diagrams of the example belt driven rear suspension bicycle with the tensioner accounting for chain growth due to vertical rear wheel travel, according to one embodiment.

FIG. 12 illustrates the example belt driven rear suspension bicycle of FIGS. 11A-B overlapping to show the movement of the various parts of the bicycle while experiencing vertical rear wheel travel, according to one embodiment.

FIGS. 13A-B illustrate detailed front and right views of a portion of a bicycle with an example tensioner, according to one embodiment.

FIGS. 14A-C illustrate simplified diagrams showing the action of the example tensioner, according to one embodiment.

### DETAILED DESCRIPTION

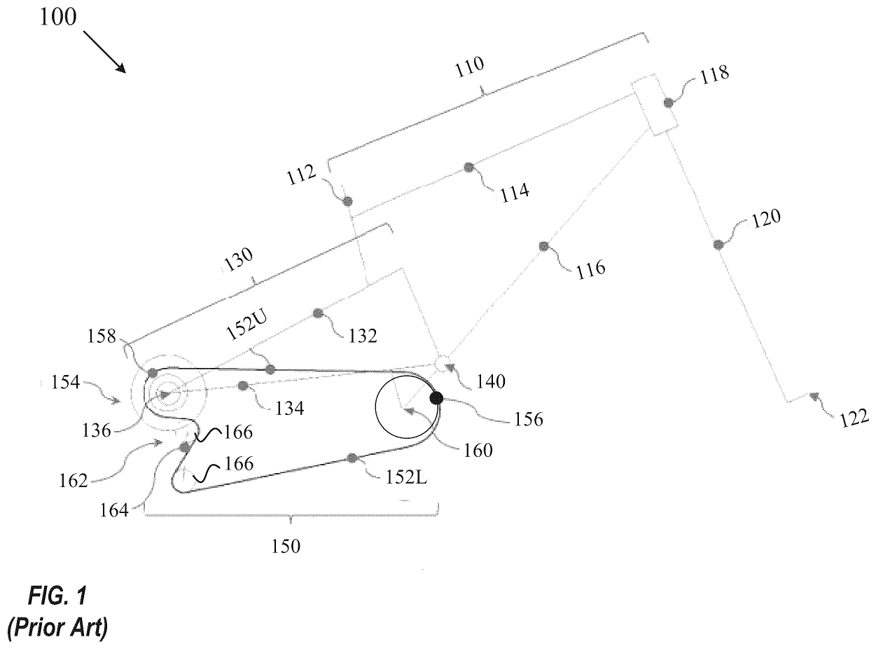

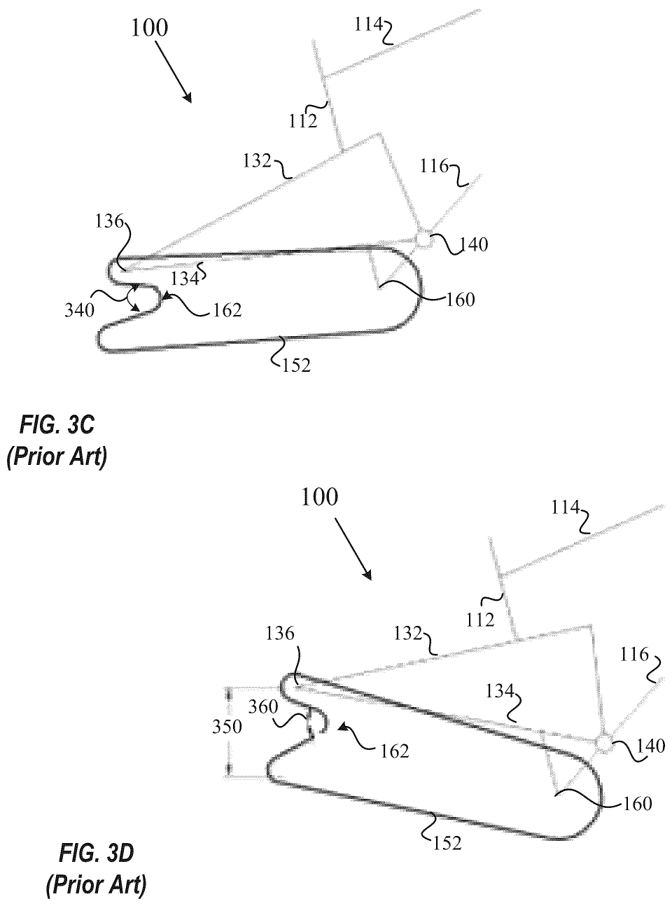

As illustrated in FIGS. 1 and 4, most common rear suspension designs have a rear suspension axis (pivot point) 140 near the crank axis 160 and the front chainring 156 or front sprocket 456. These rear suspension designs provide an axle path that rotates in a circular direction generally towards the front of the bicycle. This generally forward rotation is to the detriment of suspension performance, as the general force vector experienced by a rear wheel when it impacts a road obstacle is in a generally rearward direction. By moving the rear suspension pivot point higher (e.g., further above the crank axis 160 and the front chainring/sprocket 156, 456), the axle path of a bicycle becomes more rearward, better matching the direction of the force vector imparted by a rear wheel impact. A high rear suspension pivot point bicycle is one where the rear suspension pivot point is located high enough that an idler pulley is required to route the chain or drive belt 152, 452 coming from the rear cassette 154 or rear sprocket 454 to the front chainring/sprocket 156, 456. Bicycles having high rear suspension pivot points are becoming popular as they provide improved suspension control and a smoother ride in rough terrain.

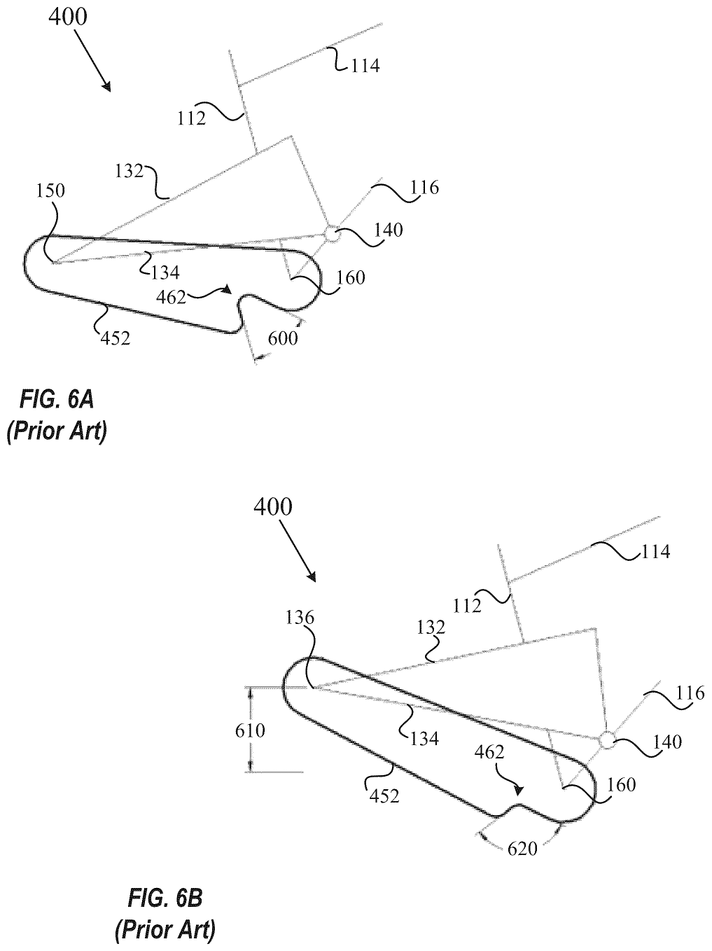

FIG. 7 illustrates a graph showing how X location (backwards and forwards) and Y location (up and down) of the suspension pivot affect chain growth. As can be seen, the Y location has more impact. The amount of chain growth will depend on the frame and suspension geometry, as well as the front, idler and rear sprocket size combination. As such, high rear suspension pivot points increase the chain growth issue when compared to most other suspension designs.

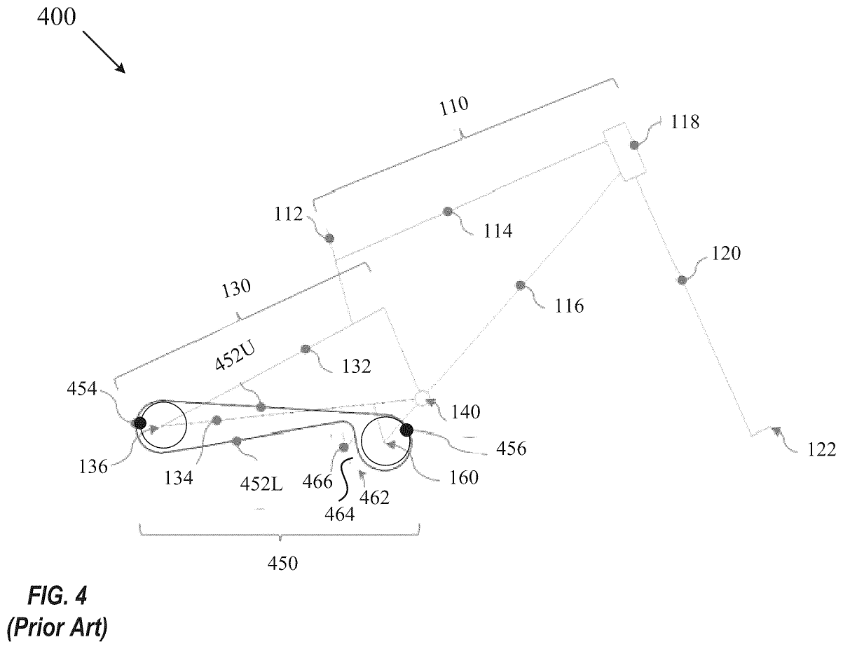

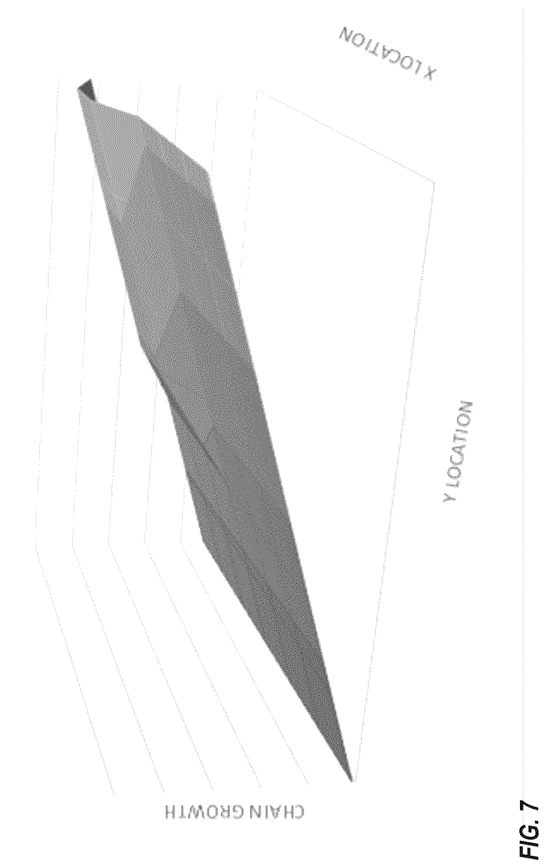

FIGS. 8A-B illustrate simple line diagrams of an example internally geared high pivot point rear suspension bicycle 800 (similar to the bicycle 400) in different rear suspension positions. The bicycle 800 includes a rear suspension axis 810 (main pivot point) that is higher than the rear suspension axis 140 of bicycle 400. The axle path of the bicycle 800 is accordingly substantially rearward. An idler pulley (not illustrated) is located in close proximity to the high rear suspension axis 810. The drive belt 452 is routed around the rear sprocket (not illustrated) centered around the rear wheel axle 136, the idler pulley located in close proximity to the high rear suspension axis 810 and the front sprocket (not illustrated) centered around the crank axis 160. FIG. 8A illustrates the bicycle 800 in an initial position and FIG. 8B illustrates the bicycle 800 with the rear wheel experiencing a vertical rear wheel travel 500 (same as that illustrated in FIG. 5B). At the vertical rear wheel travel 500, the length of the drive belt 452 required to be routed around the rear sprocket, the idler pulley, and the front sprocket has increased, resulting in a chain growth 820. For comparison purposes, with the same vertical rear wheel travel 500 and the same front and rear sprocket sizes, the chain growth 820 for the high rear suspension axis 810 is approximately 22% greater than the chain growth 510 for the rear suspension axis 140.

Like non-high pivot rear suspension bicycles, high pivot rear suspension bicycles can utilize idler pulleys, tensioners, and derailleurs to adjust the path of the belt or chain and account for changes to the virtual length of the belt/chain (chain growth).

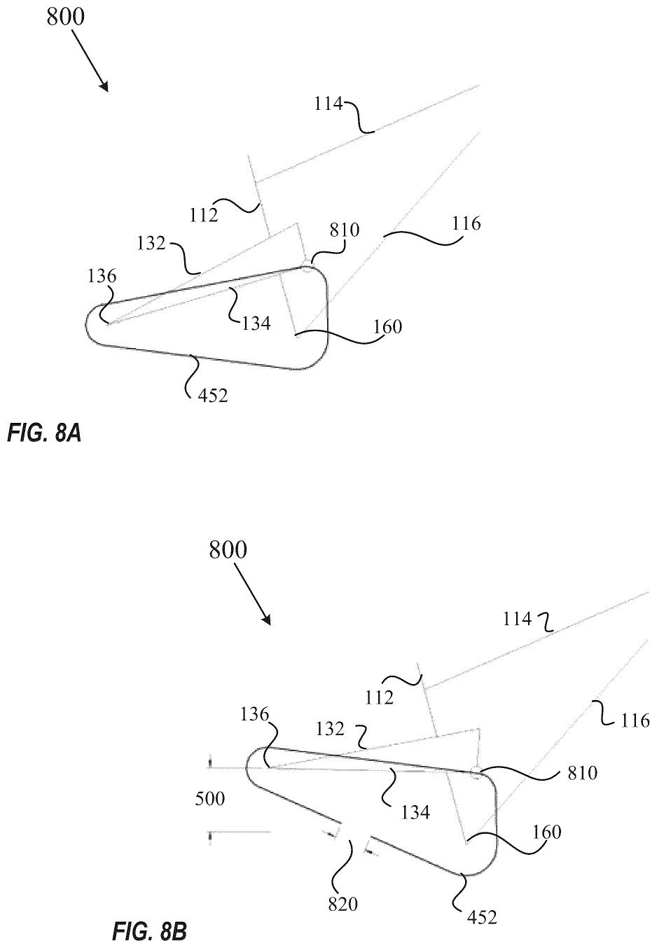

FIGS. 9A-C illustrate simple line diagrams of an example internally geared high pivot rear suspension bicycle 900 (similar to the bicycle 800) utilizing the tensioner 462 to account for virtual chain growth due to vertical rear wheel travel. As discussed above, the tensioner 462 is a spring-loaded rotating member onto which an idler pulley is mounted (actual components not illustrated for simplicity) to adjust the tension of the drive belt 452 by adjusting a driveline angle of the drive belt 452. The more vertical rear wheel travel that the bicycle experiences, the greater the driveline angle. FIG. 9A illustrates the bicycle 900 prior to the rear wheel experiencing any vertical rear wheel travel (e.g., not engaging the rear suspension). The tensioner 462 provides a driveline angle 910 at this point.

FIG. 9B illustrates the bicycle 900 experiencing vertical rear wheel travel 930 and having a driveline angle 930 to account therefore. The tensioner 462 may provide a maximum driveline angle which limits the vertical rear wheel travel that can be obtained. For example, if the driveline angle 930 was the maximum driveline angle that can be attained then the vertical rear wheel travel 920 would be the maximum attainable vertical rear wheel travel. FIG. 9C illustrates the bicycle 900 having a desired vertical rear wheel travel 940 and a driveline angle 950 that would be required to obtain that. As the driveline angle 950 is greater than the maximum driveline angle 930, the desired vertical rear wheel travel 940 is unattainable as it is greater than the maximum attainable vertical rear wheel travel 920.

One solution to solve the problem associated with a tensioner angle not being able to accommodate sufficient chain growth to meet a desired vertical rear wheel travel is to locate a tensioner closer to the high rear suspension axis 810 and idler pulley.

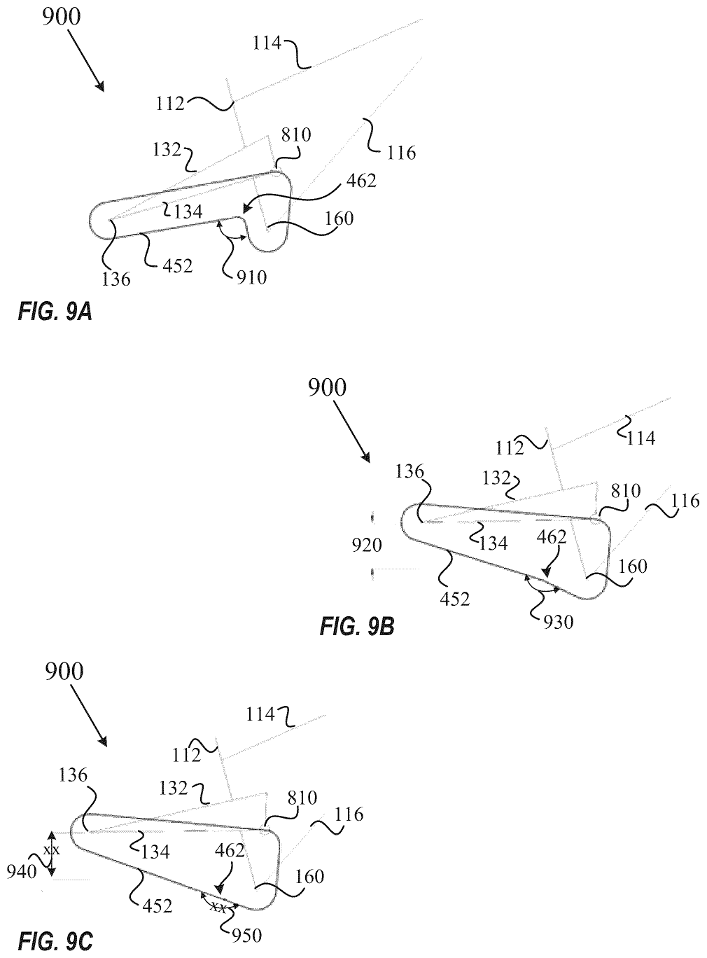

FIG. 10 illustrates a line diagram of an example internally geared (belt driven) high pivot point rear suspension bicycle 1000 including a highly placed tensioner 1010. The bicycle 1000 will use the same reference numbers to identify the same components discussed with regard to previous Figures and will not describe them below to avoid redundancy. An idler pulley 1020 is located in close proximity to the high rear suspension axis 810. The tensioner 1010 is located between the idler pulley 1020 and the front sprocket 456 (below the idler pulley 1020 and above the front sprocket 456). The tensioner 1010 includes a pivoting member 1012 with a tensioner pulley 1014 mounted thereto. The pivoting member 1012 may be mounted to the front triangle 110 (e.g., the seat tube 112). The tensioner 1010 enables the pivoting member 1012 and the tensioner pulley 1014 to pivot away from (e.g., backwards) the high rear suspension axis 810 (and idler pulley 1020 located in close proximity thereto) as well as the front sprocket 456 when experiencing vertical rear wheel travel and thus allow for chain growth in the drive belt 452. The tensioner 1010 is spring loaded so the pivoting member 1012 and the tensioner pulley 1014 pivot back towards (e.g., forwards) the high rear suspension axis 810 when experiencing less (or no) vertical rear wheel travel in order to keep the drive belt 452 appropriately tensioned. The spring may be secured to the pivoting member 1012 and the front triangle 110 (e.g., the seat tube 112).

The drive train 450 of the bicycle 1000 includes the drive belt 452, the rear sprocket 454, the idler pulley 1020, the front sprocket 456 and the tensioner 1010. The drive belt 452 routes around the rear sprocket 454, the idler pulley 1020, the front sprocket 456 and the tensioner pulley 1014 (an upper portion of the drive belt 452U moving forward from the rear sprocket 454 to the idler pulley 1020 and from the idler pulley 1020 to the front sprocket 456; and a lower portion 452L moving rearward from the front sprocket 456 to the tensioner pulley 1014 and from the tensioner pulley 1014 to the rear sprocket 454). Pedaling causes the rotation of the front sprocket 456 which will in turn rotate the drive belt 452 which in turn will rotate the rear sprocket 454 and the rear wheel.

It should be noted that the internally geared bicycle 1000 is not limited to being a belt driven bicycle. Rather, the bicycle could be a chain driven bicycle and utilize a chain drive instead of the drive belt 452 and chainrings instead of sprockets 454, 456 and pulleys 1014, 1020. If the bicycle 1000 is an electric bicycle, it will include an electric motor (not illustrated) to provide, or assist with, the movement thereof.

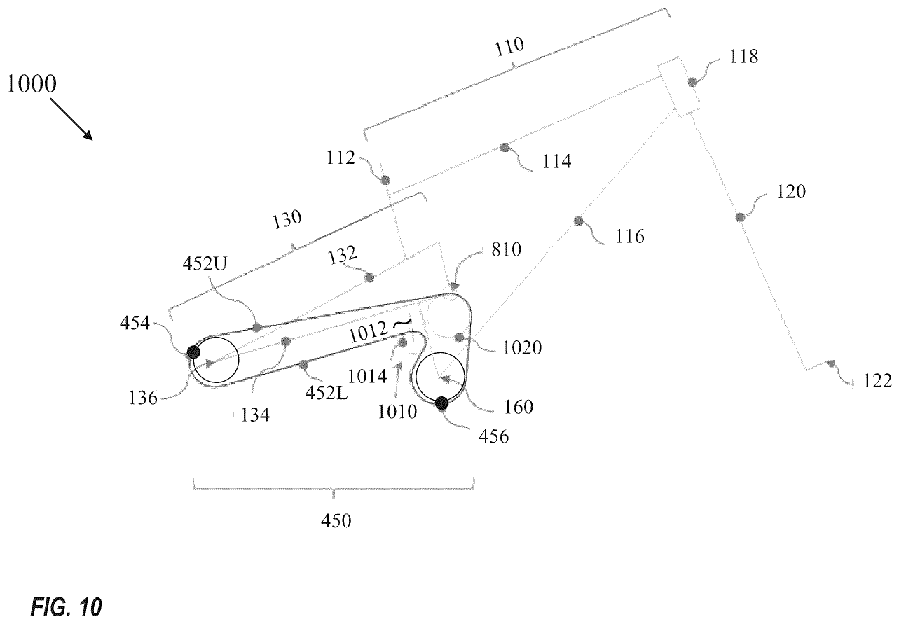

FIGS. 11A-B illustrate simplified line diagrams of the example internally geared (e.g., belt driven) rear suspension bicycle 1000 with the tensioner 1010 accounting for chain growth due to vertical rear wheel travel. The actual components of the tensioner 1010 are not illustrated for simplicity. Rather, the tensioner 1010 is simply illustrated as providing a driveline angle that adjusts the path of the drive belt 452 back to the rear sprocket (rear wheel axis 136 identified for simplicity). The more vertical rear wheel travel that the bicycle experiences, the greater the driveline angle. The high mounting of the tensioner 1010 (e.g., in proximity to the high rear suspension axis 810; between the crank axis 160 and the idler pulley) allows smaller driveline angle changes to account for chain growth which in turn enables more vertical rear wheel travel.

FIG. 11A illustrates the bicycle 1000 prior to the rear wheel experiencing any vertical rear wheel travel (e.g., not engaging the rear suspension). The tensioner 1010 provides a driveline angle 1100 at this point. The driveline angle 1100 is less than an equivalent driveline angle 910. FIG. 11B illustrates the bicycle 1000 experiencing vertical rear wheel travel 1110 and having a driveline angle 1120 to account therefore. The vertical rear wheel travel 1110 is greater than maximum vertical rear wheel travel 920 and the desired vertical rear wheel travel 940 but the driveline angle 1120 is less than either driveline angle 930, 950 (and possibly even the driveline angle 910). The change between the initial driveline angle 1100 associated with no vertical rear wheel travel (FIG. 11A) and the driveline angle 1120 associated with the vertical rear wheel travel 1110 (FIG. 11B) is substantially less than the change between the initial driveline angle 910 associated with no vertical rear wheel travel (FIG. 9A) and the driveline angle 930 associated with the vertical rear wheel travel 920 (FIG. 9B).

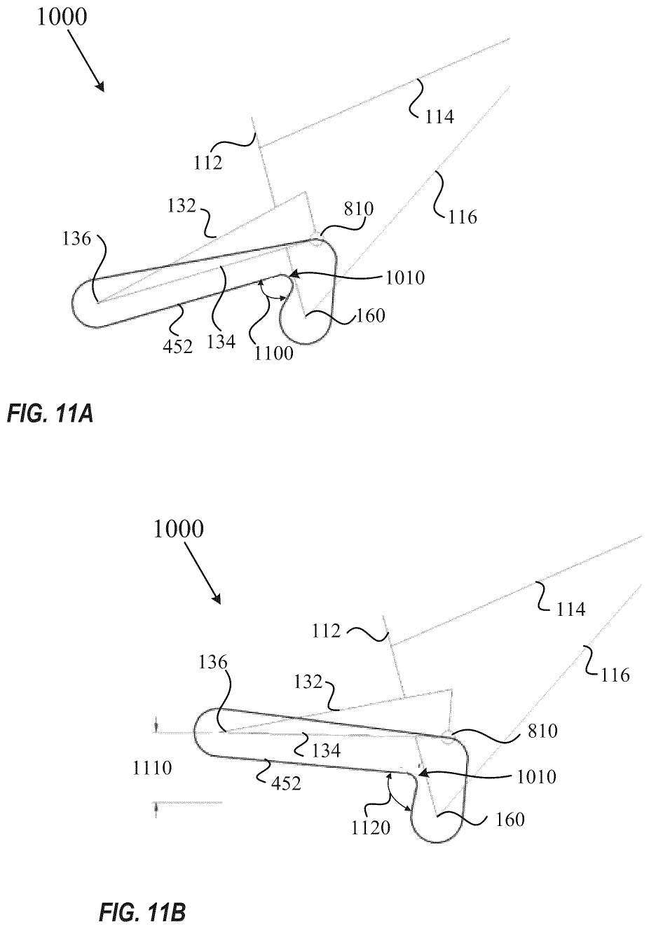

FIG. 12 illustrates the example belt driven rear suspension bicycle 1000 of FIGS. 11A-B overlapping to show the movement of the various parts of the bicycle 1000 while experiencing vertical rear wheel travel 1110. The parts of the bicycle 1000 associated with FIG. 11A (prior to the rear wheel experiencing any vertical rear wheel travel) are identified by their associated numbers and the parts of bicycle 1000 associated with FIG. 11B (experiencing vertical rear wheel travel 1110) are identified by their associated numbers with a V appended thereto. As can be seen, the various components of the swing arm 130 and the drive train 450 move upward as the bicycle 1000 experiences the vertical rear wheel travel 1110. The tensioner pulley 1014 and the pivoting member 1012 (not identified for ease) pivot away from the high rear suspension axis 810 (e.g., pivot backwards) as the bicycle 1000 experiences the vertical rear wheel travel 1110. The amount of pivot of the tensioner (difference between 1014 and 1014V) is indicated by angle 1210. A spring 1200 is shown secured to the seat tube 112 on one end and the tensioner on the other to provide the tension to have tensioner pivot back towards the high rear suspension axis 810 (e.g., pivot forwards) when not experiencing (or experiencing less) vertical rear wheel travel.

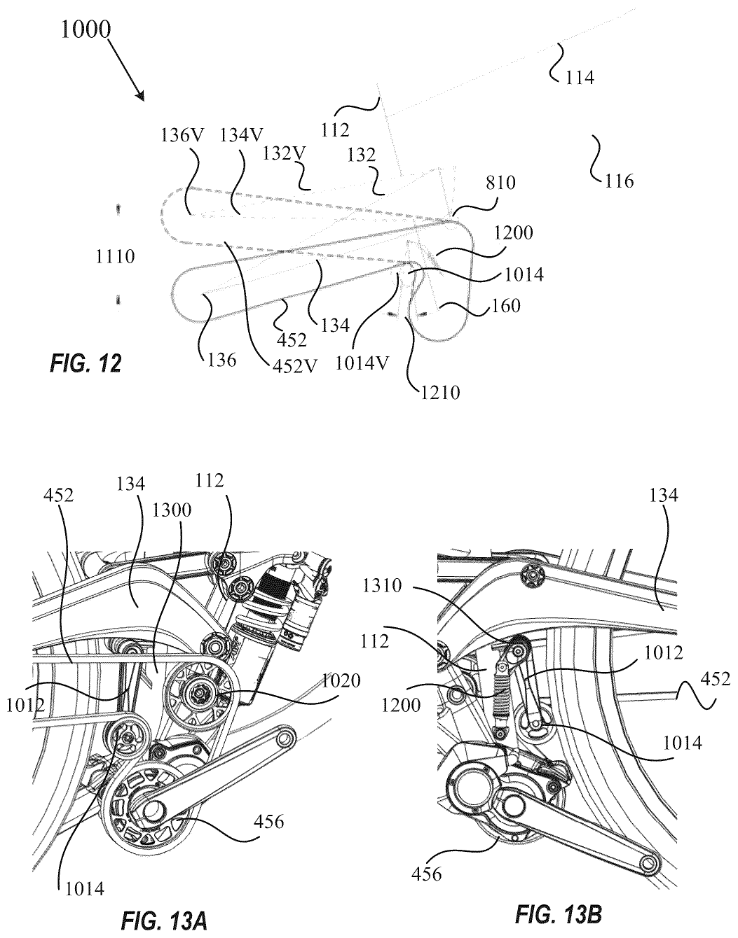

FIGS. 13A-B illustrate detailed front and right views of a portion of a bicycle with an example tensioner. The tensioner includes a pivoting member 1012, a tensioner pulley 1014, a spring (compression spring) 1200 and a spring arm 1310. The tensioner is mounted to a bracket 1300 that extends backwards from the seat tube 112. One end of the pivoting member 1012 and one end of the spring arm 1310 are secured to the bracket 1300 (separate sides of the bracket 1300) so that the two are connected to one another at a defined angle and rotate with relation to each other. A second end of the pivoting member 1012 has the tensioner pulley 1014 mounted thereto. A second end of the spring arm 1310 is secured to one end of the spring 1200 and a second end of the spring 1200 is secured to the seat tube 112. When the bicycle experiences vertical rear wheel travel, the pivoting member 1012 swings away from the seat tube 112 and the spring arm 1310 rotates in same direction (e.g., swings downwards) providing a force on the spring 1200 and causing the spring 1200 to compress. When the tension caused by the vertical rear wheel travel is reduced, the force on the spring 1200 is reduced so that the spring 1200 extends upwards which pushes the spring arm 1310 upwards (rotate in opposite direction as when experiencing increased vertical rear wheel travel). The rotation (e.g., upward movement) of the spring arm 1310 causes the pivoting member 1012 to pivot back towards the seat tube 112.

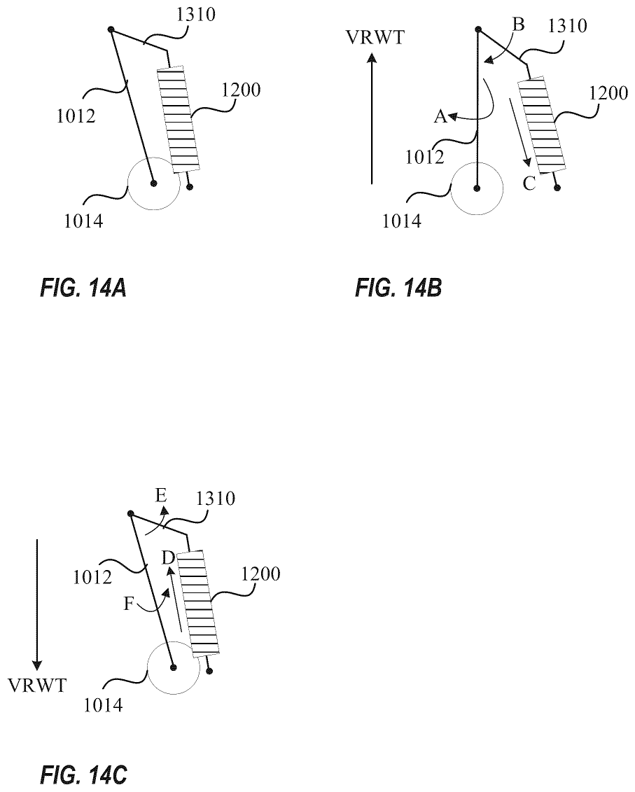

FIGS. 14A-C illustrate simplified diagrams showing the action of the example tensioner of FIGS. 13A-B. It should be noted that FIGS. 14A-C are side views where if the tensioner was located on a bicycle the front triangle would be in front of the tensioner (to the right) and the swingarm would be behind the tensioner (to the left). The pivoting member 1012 and the spring arm 1310 are secured together at a pivot point, the spring arm 1310 is secured to the spring 1200 and the spring 1200 is secured to the bicycle frame. FIG. 14A illustrates the tensioner prior to the bicycle experiencing any vertical rear wheel travel. The spring 1200 is at its initially configured size (e.g., extended with some preloaded force) which pushes the spring arm 1310 up and pivots the pivoting member 1012 in toward the frame.

FIG. 14B illustrates the tensioner when the bicycle starts to experience vertical rear wheel travel. The tension on the drive belt caused by the vertical rear wheel travel causes the pivoting member 1012 to pivot away from the high pivot point (e.g., backwards towards the rear wheel) as indicated by A. As illustrated from this side view, the pivoting away is a clockwise rotation of the pivoting member 1012 (would be counterclockwise from opposite side view). However, the pivoting is not limited to a clockwise rotation from this view (e.g., could be counterclockwise rotation). The linkage between the pivoting member 1012 and the spring arm 1310 causes the spring arm 1310 to rotate in same direction as the pivoting member 1012 (e.g., pivot away from the high pivot point) as indicated by B. The pivoting of the spring arm 1310 provides a force on the spring 1200 to change the size of the spring from its initially configured size as indicated by C. As illustrated, the force on the spring 1200 is downwards which results in the compression of the spring 1200. However, the force is not limited to compressing the spring 1200 (e.g., force could expand the spring).

FIG. 14C illustrates the tensioner when the vertical rear wheel travel the bicycle is experiencing is reduced or eliminated. The tension on the drive belt is reduced which reduces the force provided on the spring 1200 by the spring arm 1310 which enables the spring 1200 to begin to return (move towards) its initially configured size as indicated by D. As illustrated, the spring 1200 expands as the force is reduced. However, the spring 1200 is not limited to expanding to return to its initially configured size (e.g., could compress). The return of the spring 1200 to its initially configured size (expansion of the spring) causes the spring arm 1310 to rotate in opposite direction as it did when experiencing increased vertical rear wheel travel (e.g., pivot back towards the high pivot point) as indicated by E. As illustrated in this side view, the pivoting is in a counterclockwise rotation of the spring arm 1310. However, the pivoting is not limited to a counterclockwise rotation from this view (e.g., could be clockwise rotation). The linkage between the pivoting member 1012 and the spring arm 1310 causes the pivoting member 1012 to pivot back towards the high pivot point as indicated by E.

It should be noted that the tensioner is not limited to the configuration and operation disclosed in FIGS. 13A-B and 14A-C. Rather other arrangements and configurations that provide the pivoting away from the high suspension point when experiencing increased vertical real wheel travel and pivot back towards the high suspension point when experiencing decreased vertical real wheel travel could be utilized without departing from the scope of the invention. For example, the pivoting member and the spring arm could be a single component having two sides having a defined angle therebetween. The angle between the pivoting member and the spring arm could be such that when the pivoting member pivots away from the high pivot point the spring arm actually pivots towards the high pivot point and vice versa. The pivot point of the pivoting member could be secured to the frame at a lower point than the pulley end such that the tensioner pulley would rotate counterclockwise in the side views of FIGS. 14A-C. The spring could be located above the spring arm and be an expansion spring where the pivoting of the spring arm expands the spring and when the tension is released the spring compresses back to its initially configured state and pulls the spring arm back. The bracket that the tensioner is secured to, could be located on other tubes of the front triangle. The pivoting member and the spring could be secured to different tubes. One skilled in the art would understand the various manners in which the pivoting necessary could be achieved.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A high pivot point rear suspension bicycle comprising
a frame including a front triangle and a swingarm;
a rear suspension pivot point between the front triangle and the swingarm, wherein location of the rear suspension pivot point provides a predominantly rearward axle path; and
a drive train including a drive belt, a rear sprocket located at a rear wheel axis, an idler pulley located in close proximity to the rear suspension pivot point, a front sprocket located at a crank axis, and a tensioner located between the idler pulley and the front sprocket, wherein the drive belt traverses from the rear sprocket to the idler pulley, from the idler pulley to the front sprocket, from the front sprocket to the tensioner and from the tensioner back to the rear sprocket, wherein the tensioner is to pivot away from the rear suspension pivot point when vertical rear wheel travel of the bicycle increases to allow for chain growth in the drive belt.

2. The bicycle of claim 1, wherein the tensioner is to pivot back towards the high rear suspension axis when the vertical rear wheel travel of the bicycle decreases in order to keep the drive belt appropriately tensioned.

3. The bicycle of claim 1, wherein the tensioner includes a pivoting member and a pulley mounted to a far end of the pivoting member.

4. The bicycle of claim 3, wherein
the drive belt traverses the pulley; and
the far end of pivoting member and the pulley pivot away from the rear suspension pivot point to adjust a path of the drive belt when the vertical rear wheel travel of the bicycle increases.

5. The bicycle of claim 4, wherein the tensioner further includes a spring to cause the far end of the pivoting member and the pulley to pivot back towards the high rear suspension axis when the vertical rear wheel travel of the bicycle decreases in order to keep the drive belt appropriately tensioned.

6. The bicycle of claim 1, wherein the tensioner includes
a pivoting member having a first end pivotally secured to a first location of the front triangle;
a pulley secured to a second end of the pivoting member;
a spring arm having a first end pivotally secured to the first location of the front triangle and connected to the first end of the pivoting member at a defined angle; and
a spring having a first end secured to a second location of the front triangle and a second end secured to a second end of the spring arm.

7. The bicycle of claim 6, wherein
the second end of the pivoting member and the pulley pivot away from the rear suspension pivot point based on increased tension on the drive belt created when the vertical rear wheel travel of the bicycle increases;
the second end of the spring arm rotates in same direction as the second end of the pivoting member in response to the pivoting of the second end of the pivoting member; and
a force is applied to the spring by the rotation of the second end of the spring arm to change size of the spring away from its initially configured size.

8. The bicycle of claim 7, wherein
the size of the spring moves towards its initially configured size when tension on the drive belt is reduced based on the vertical rear wheel travel decreasing;
the second end of the spring arm rotates in opposite direction in response to the change in the spring size; and
the second end of the pivoting member and the pulley pivots back towards the rear suspension pivot point in response to the rotation of the second end of the spring arm.

9. The bicycle of claim 6, wherein the second location of the front triangle is below the first location of the front triangle.

10. The bicycle of claim 6, wherein
the first location of the front triangle is a bracket extending from a tube of the front triangle; and
the pivoting member and the spring arm are secured to the bracket.

11. The bicycle of claim 1, further comprising a gear box located at the crank axis to provide internal gearing for the bicycle.

12. The bicycle of claim 1, further comprising a geared hub located at the rear axle axis to provide internal gearing for the bicycle.

13. The bicycle of claim 1, further comprising an electric motor.

14. A tensioner for use with a high pivot point rear suspension bicycle to allow for chain growth and to maintain appropriate tension, the tensioner comprising:
a pivoting member having a first end pivotally secured to a first location of a front triangle of the bicycle;
a pulley secured to a second end of the pivoting member;
a spring arm having a first end pivotally secured to the first location of the front triangle and connected to the first end of the pivoting member at a defined angle; and
a spring having a first end secured to a second location of the front triangle and a second end secured to a second end of the spring arm.

15. The tensioner of claim 14, wherein
the second end of the pivoting member and the pulley pivot away from a rear suspension pivot point based on increased tension on a drive belt of the bicycle created when the vertical rear wheel travel of the bicycle increases;
the second end of the spring arm rotates in same direction as the second end of the pivoting member in response to the pivoting of the second end of the pivoting member; and
a force is applied to the spring by the rotation of the second end of the spring arm to change size of the spring away from its initially configured size.

16. The tensioner of claim 15, wherein
the size of the spring moves towards its initially configured size when tension on the drive belt is reduced based on the vertical rear wheel travel decreasing;
the second end of the spring arm rotates in opposite direction in response to the change in the spring size; and
the second end of the pivoting member and the pulley pivot back toward the rear suspension pivot point in response to the rotation of the second end of the spring arm.

17. The tensioner of claim 14, wherein the rear suspension bicycle includes
a frame including the front triangle and a swingarm;
a rear suspension pivot point between the front triangle and the swingarm, wherein location of the rear suspension pivot point provides a predominantly rearward axle path; and
a drive train including a drive belt, a rear sprocket located at a rear wheel axis, an idler pulley located in close proximity to the rear suspension pivot point, a front sprocket located at a crank axis, and the tensioner located between the idler pulley and the front sprocket, wherein the drive belt traverses from the rear sprocket to the idler pulley, from the idler pulley to the front sprocket, from the front sprocket to the tensioner and from the tensioner back to the rear sprocket.

18. The tensioner of claim 14, wherein the second location of the front triangle is below the first location of the front triangle.

19. The tensioner of claim 14, wherein
the first location of the front triangle is a bracket extending from a tube of the front triangle; and
the pivoting member and the spring arm are secured to the bracket.

20. The tensioner of claim 14, wherein the spring is a compression spring.
